(19) United States
(12) Patent Application Publication
(10) Pub. No.: US 2009/0249182 A1
(43) Pub. Date: Oct. 1, 2009

(54) NAMED ENTITY RECOGNITION METHODS AND APPARATUS

(75) Inventors: Beatrice Symington, Edinburgh (GB); Barry Haddow, Edinburgh (GB)

Correspondence Address: NIXON & VANDERHYE, PC, 901 NORTH GLEBE ROAD, 11TH FLOOR, ARLINGTON, VA, 22203, US

(73) Assignee: ITI Scotland Limited, Strathclyde (GB)

(21) Appl. No.: 12/059,247

(22) Filed: Mar. 31, 2008

(51) Int. Cl. G06F 17/21

(52) U.S. Cl. 715/209

(57) ABSTRACT

There is disclosed a method of recognising named entities in a text-containing document, represented by text document data. The received text document data comprising a plurality of tokens, one or more of the said plurality of tokens being part of a plurality of entities. The text document data is analysed using one or more tagging modules which are operable to determine token label data in respect of at least the tokens which are part of a plurality of entities, wherein the token label data output by the one or more tagging modules comprises data representative of the location of the token within each of a plurality of entities. The token label data representative of the location of the token within each of a plurality of entities is used to determine the beginning and end of the entities which have been identified in the text document data. A plurality of tagging modules may be employed, each of which is adapted to determine token label data representative of the location of a token within a different subset of the entities represented by the text document data, wherein the token label data determined by the plurality of tagging modules together is representative of the location of the said token with a plurality of entities. A single tagging module may be employed which determines a compound tag selected from a group of compound tags, the ground of compound tags including different tags in respect of a plurality of different combinations of the location of a respective token within a plurality of entities.

### FIELD OF THE INVENTION

The present invention relates to the field of recognising named entities (NE) in text documents comprising tokens which are part of more than one entity, for example because they are part of nested entities.

### BACKGROUND TO THE INVENTION

When carrying out information extraction on text documents, it is common to consider the document as a series of individual tokens, which are typically identified by a tokeniser module. Tokens are typically words, or parts of words, as appropriate to the application.

A standard method of carrying out named entity recognition (NER) is to convert NER to a sequence tagging problem using the BIO encoding (Ramshaw & Marcus, 1995). In the BIO encoding, each token is allocated a label, in the form of a tag, to indicate whether it is at the beginning (B), inside (I), or outside (O) of an entity. This method is suitable for analysing non-nested, non-overlapping, continuous entities but is not directly applicable to the analysis of text-containing documents including tokens which are part of more than one entity, for example because two or more entities are nested.

In data sets consisting of natural language text, particularly text-containing documents relating to scientific fields such as biomedical publications, it is however common to find surface forms which are part of more than one entity, for example where entities are nested inside other entities. For example, the Genia corpus (OHTA et al., 2002.) contains nested entities such as:
<RNA><DNA>CIITA</DNA>mRNA</RNA>
   where the string “CIITA” denotes a DNA molecule but the entire string “CIITA mRNA” refers to an RNA molecule and so “CIITA mRNA” refers to nested entities, namely “CIITA mRNA” and “CIITA”. Accordingly, the token “CITTA” is part of two entities. It is also common to find entities which overlap with each other or which are discontinuous, such as “human interleukin-4” in the text segment “human interleukin-2 and -4”.

The majority of NER studies on corpora containing nested structures focus on recognising the outermost (non-embedded) entities (e.g. Kim et al. 2004), as they contain the most information, including that of embedded entities (Zhang et al., 2004). This enables a simplification of the NER task to a sequential analysis problem, but the effectiveness of this approach is limited.

Accordingly, the present invention addresses the problem of providing improved or alternative methods of recognising named entities in text-containing documents which include tokens that are part of more than one entity.

By a “text-containing document” we refer to a document which includes text and optionally formatting, graphics and so forth. By “text document data” we refer to a data which specifies a document including text to be rendered by a suitable application. Text document data may be in any appropriate computer-readable format, for example, as plain text in a recognised character set, Portable Document Format (PDF), or in a mark-up language such as eXtensible Markup Language (XML).

### SUMMARY OF THE INVENTION

The invention concerns methods and computing apparatus for recognising named entities in a text-containing document represented by text document data. Tokenised text document data is received, which may include one or more tokens which are pan of a plurality of entities, for example nested entities. The text document data is analysed using one or more tagging modules which are operable to determine token label data in respect of at least tokens which are part of a plurality of entities (and typically each token within the text document data). According to the invention, at least in respect of tokens which are part of a plurality of entities, the token label data output by the one or more tagging modules comprises data representative of the location of a respective token within each of a plurality of entities. The beginning and end of entities represented by the text document data are determined from the token label data representative of the location of tokens within each of a plurality of entities. We have found that this strategy enables nested named entities to be identified in text-containing documents.

In some embodiments, the text document data is analysed using a plurality of tagging modules, each of which is adapted to determine token label data representative of the location of a token within a different subset of the entities represented by the text document data. In this case, the token label data output by the plurality of tagging modules, when considered together, includes data representative of the location of the individual token within a plurality of entities, typically one from each entity subset. Typically, the plurality of tagging modules are obtained by training a suitable tagging module, such as a tagger using a trainable statistical model, on text document data in which a subset of entities, corresponding to those which the tagging module will be employed to identify, are used to train the respective tagging module.

In some embodiments, employing what is referred to herein as inside-out layering, the entity subsets each comprise entities which are contained within different numbers of other entities. For example, one subset may comprise entities that contain no other entities. A second subset may comprise entities that contain exactly one other entity, and so forth.

In some embodiments, employing what is referred to herein as outside-in layering, the entity subsets each comprise entities which are contained within different numbers of other entities. For example, one subset may comprise entities that are not contained within any other entities. A second subset may comprise entities that are contained within exactly one other entity, and so forth,

In some embodiments, employing what is referred to as cascading, the subsets of entities comprise different groups of one or more types of entity. In each case, the plurality of tagging modules have typically been obtained by training a respective module using training data in which only the entities of the corresponding type or types are taken into account.

In some embodiments, employing what is referred to as joined-up tagging, each token has a compound tag associated therewith, wherein the compound tag is selected from a group of compound tags, where a different compound tag is included in respect of different combinations of possible locations (such as a the beginning of, or within) the token within a plurality of entities.

### DESCRIPTION OF THE DRAWINGS

An example embodiment of the present invention will now be illustrated with reference to the following Figures:

FIG. 1 is a schematic diagram of computing apparatus;

FIG. 2 is a schematic diagram of data and software modules processed and executed by the computing apparatus;

FIG. 3 is a sentence which makes up a part of a text-containing document;

FIG. 4 is an XML file which is output from a process which successfully carries out named entity recognition on the sentence;

FIG. 5 is a schematic diagram of a procedure for training a first example of a named entity recognition module;

FIG. 6 is a schematic diagram of the execution of a first example of a named entity recognition module;

FIG. 7 is the output from a tagging procedure according to a first example embodiment;

FIG. 8 is the output from a second example tagging procedure;

FIG. 9 is a schematic diagram of a procedure for training a third example named entity recognition module;

FIG. 10 is a schematic diagram of a process for carrying out named entity recognition using a third example named entity recognition module;

FIG. 11 is the data output by a third example of a named entity recognition module;

FIG. 12 is the data output by a fourth example tagging procedure;

FIG. 13 illustrates the cross-validation F1-scores for different modelling techniques in an experimental procedure; and

FIG. 14 illustrates individual counts and scores of the most frequent Genia and all EPPI entity types using third example tagging method.

### DETAILED DESCRIPTION OF EXAMPLE EMBODIMENTS

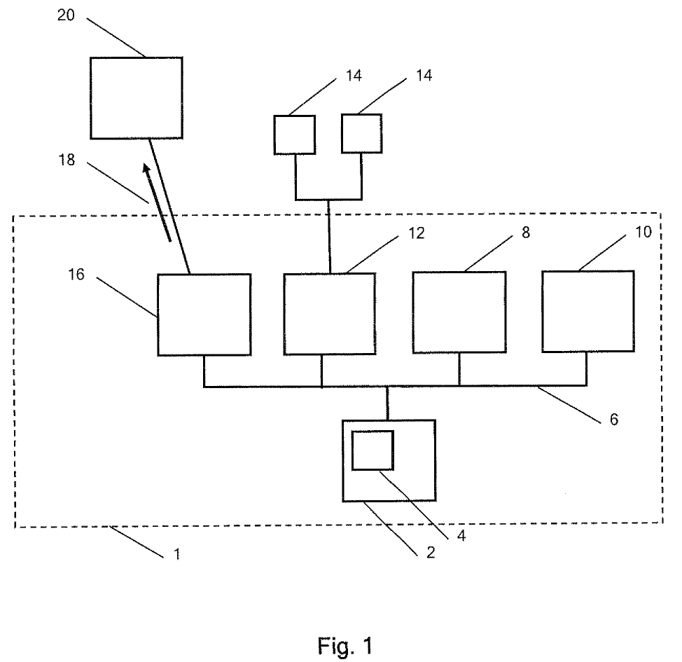

With reference to FIG. 1, the methods of the present invention are typically implemented using conventional computing apparatus 1, having a CPU 2, which includes internal memory 4 and communicates through one or more system buses 6 with external RAM memory 8, a hard drive 10, device interfaces 12 for the connection of input peripherals 14, and a display interface 16 which produces a video output signal 18, which can be rendered by a video display 20. One skilled in the art will also appreciate that the methods of the present invention can be carried out using a plurality of distinct computing devices, for example using one or more servers and a plurality of client computers.

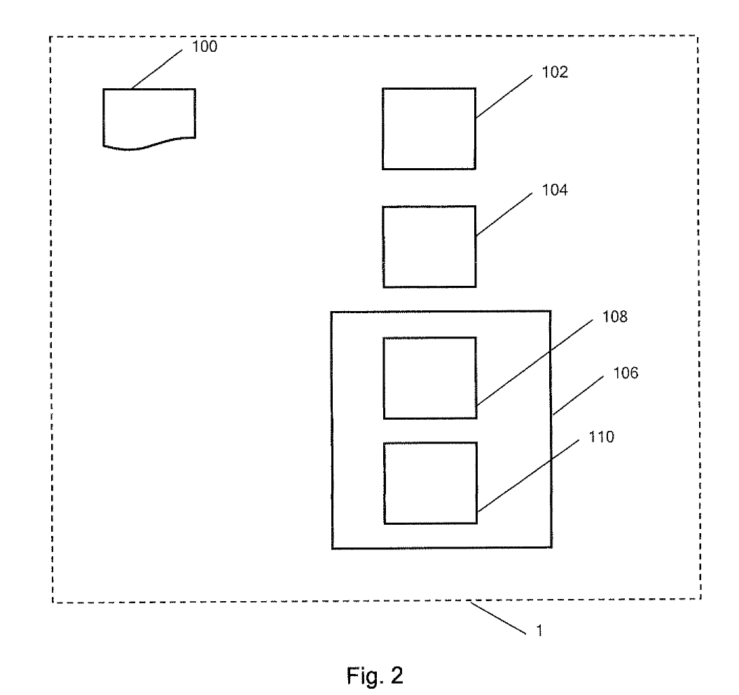

With reference to FIG. 2, the computing apparatus stores, for example on the hard drive, or has access to, a plurality of text document files 100, which are to be analysed, and a plurality of software modules, including a pre-processing module 102, a tokeniser 104 and a named entity recognition module 106 comprising one or more tagging modules 108 and a tag processing module 110. The text document files (functioning as text document data) represent text-containing documents. The text document files may include text and additional presentational information, such as text formatting, graphics etc.

In use, each of the text document files is initially pre-processed by the pre-processing module into a standard format for subsequent processing. Different pre-processing modules may be provided to convert text document files from different formats and the resulting pre-processed text document files are, in this example, in the form of XML files. Each successive stage introduces additional XML markup to the text document file, which markup is referred to herein as annotation.

Following pre-processing, the text document files are tokenised by the tokeniser. Named entities are then recognised in a two-step procedure in which the tokenised document file is tagged by one or more tagging modules, each of which outputs a separate tagged document (which tag data functions as token label data), or provides separate tag data (which functions as token label data). A tag processing module reads the output of the or each tagging module and labels entities identified by the one or more tagging modules within the text document files. In text mining applications, there will typically be further stages of processing, such as term identification and relation extraction. Extracted information, such as recognised entities and relations, may be presented to a curator for review.

Four example embodiments of the invention will now be described, each of which utilises a tagging module, or tagging modules, which have been trained on different training data. The tagging module or modules in each example embodiments store different token label data in connection with each token which is found within the text document files. The four example embodiments use tagging conventions which we will refer to inside-out layering, outside-in layering, cascading, and joined label tagging.

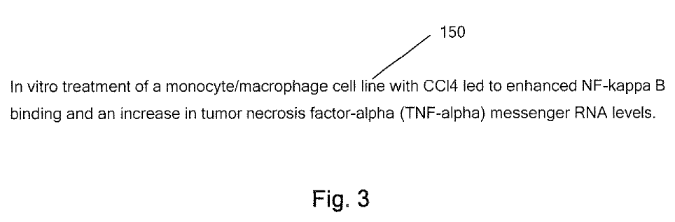

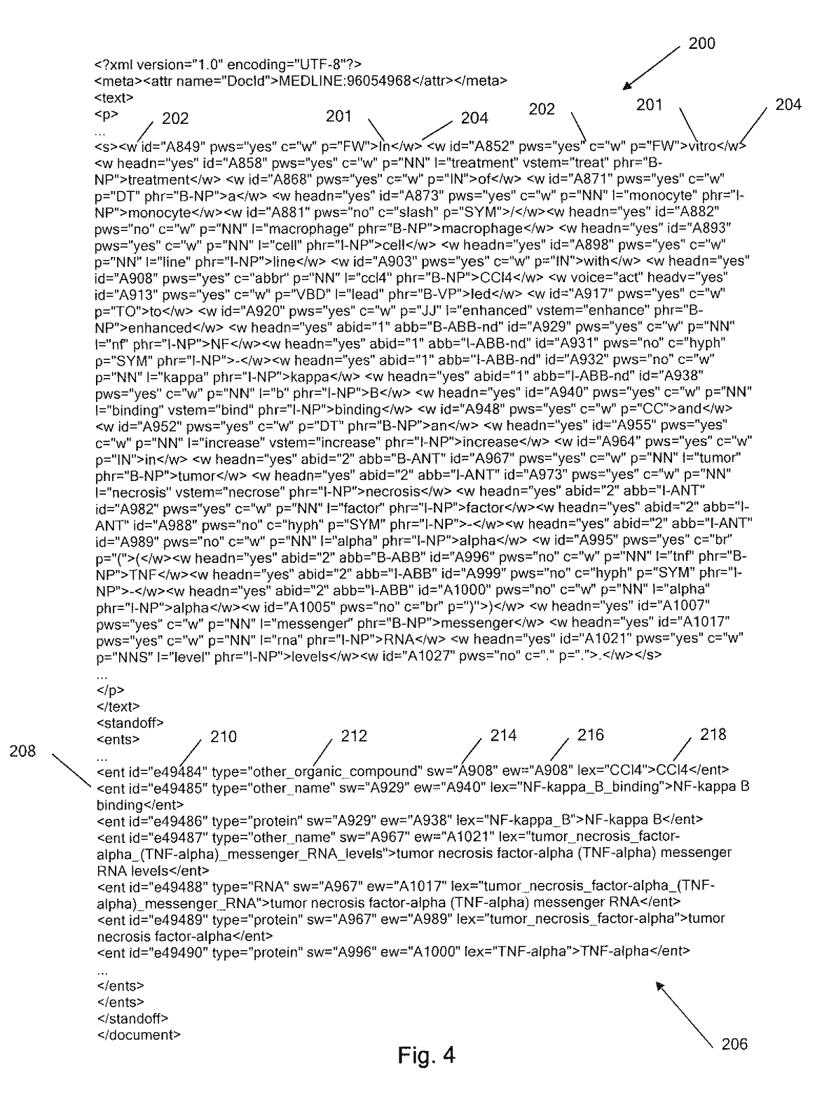

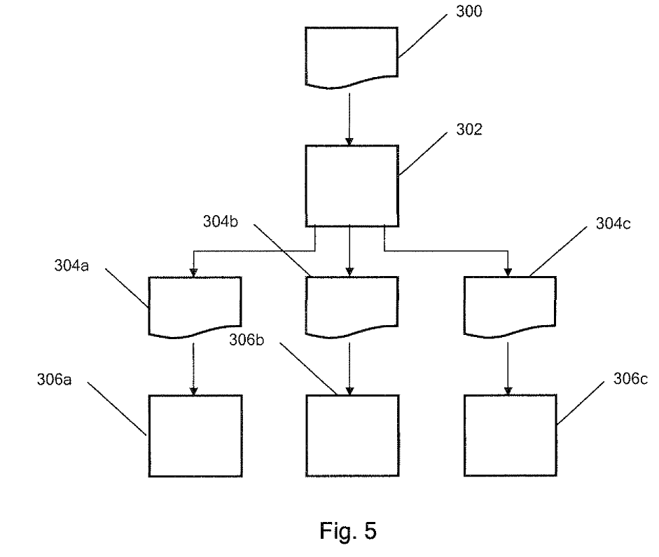

Each example will be illustrated with reference to the sample data shown in FIGS. 3 and 4. FIG. 3 is an example of a sentence 150 which makes up part of a text document represented by a text document file. FIG. 4 illustrates the XML file 200 which would be output from a process which carried out named entity recognition successfully on this sentence. Each token 201 is included between <w> and </w> elements 202, 204, and each token is uniquely numbered, in this case from A849 to A1027. The XML file illustrated in FIG. 4 includes stand-off annotation 206 which lists recognised entities. The data concerning each recognised entity 208 has a unique identifier 210, a type 212, an identifier of the token where it begins 214 and the token where it ends 216, and the character string which makes up the entity 218. XML files of corresponding format can be prepared by human annotators for use as training data to prepare the tagging module, or modules. One skilled in the art will appreciate that annotations may be embedded in the body of the XML file, which represents the text document, rather than as stand-off at a separate location to the main body of the file, or stored in a file or database which is entirely separate to the text document file.

### Example 1

### Inside-Out Layering

A first example named entity recognition module treats each text document file as comprising a series of logical layers of entities, each logical layer comprising a subset of the entities represented in the text document file. The first layer is made up of all entities which do not contain other entities. The second layer is composed of all entities which contain only one layer of nested entities. The third layer is composed of all those entities which contain two layers of nested entities. Fourth and further layers may be provided if desired. Only two layers may be provided, for example when analysing data containing only two layers of nested entities.

A tagging module is provided in respect of each layer. Accordingly, each tagging module recognises a different subset of the entities in the text document file. Each tagging module is trained using the C&C tagger discussed further below, which makes use of a Maximum Entropy Markov Model, trained on suitable training data, although one skilled in the art will recognise that other taggers suitable for conventional BIO labelling, including other taggers based on trainable statistical models, can be readily adapted for use in the present method, or potentially used without modification except for training on data in which the appropriate subset of entities are identified.

Each tagging module is prepared by a training process. Before training, a training set of carefully checked human annotated text documents 300 (referred to in the field as “gold standard”) are prepared. Each text document in the training set includes mark-up indicating the location of the start and end of named entities within the text document, including nested entities. In some applications, only selected named entities will be identified. For example, only certain types of entities may be identified.

A document processing module 302 prepares separate training documents for each tagging module. First, second and third training documents 304a, 304b, 304c are prepared from each text document in the training set. The first training documents for training the first tagging module 306a, have all entities which do not contain other entities marked up by labelling each token therein with tag data comprising a B or I tag element depending on whether the token is the beginning of, or the inside of, an entity which does not contain other entities. Other tokens are labelled with an O tag element indicating that they are not part of an entity in the respective layer. The tag data also includes a further tag element indicating the type of entity which the B or I tag elements concern, although it is not in this case necessary to identify an entity type in connection with O tag elements. The second training documents for training the second tagging module 306b have been annotated to mark up all entities which contain one nested entity only. Each is marked up by labelling each token which makes up part of the said entities with a B or I tag element, depending on whether the token is the beginning of or inside an entity which contains one other nested entity. Tokens which are not part of entities which contain one nested entity are labelled with an O tag element. Again, a tag element is also provided to identify the type of entity which the B or I tag elements concern. Third training documents are also prepared, for training the third tagging module 306c, in which each token is marked up depending on whether the token is the beginning of, or inside an entity which contains two levels of nested entities, along with an identifier of the type of entity which the B or I tag element concerns. Again, the remaining tokens are marked up with an O. The resulting one or more files with marked up tag data, including B, I, or O tag elements and tag elements denoting entity types where appropriate, function as token label data.

Each tagging module is trained on the respective set of training documents 306a, 306b, 306c. Accordingly, the method of training each tagging module corresponds to conventional methods of training BIO tagging modules, except that the annotated documents which are used to train each tagging module differ in that the same documents have annotated differently for each tagging module, as described above, so that each tagging module is trained on documents in which each token has been labelled with the location of the respective token in entities with a different level of nesting. Thus, known BIO tagging modules may be used, without modification, or minimal modification.

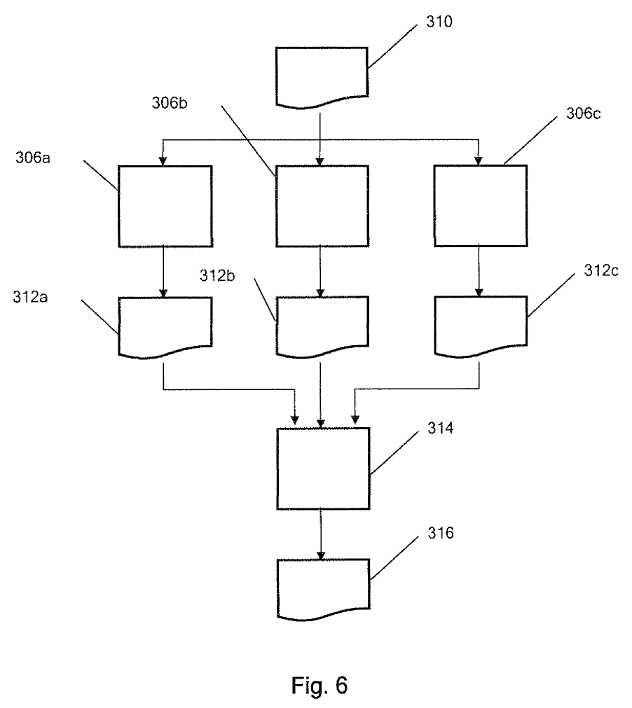

FIG. 6 illustrates the procedure for carrying out named entity recognition at run time, for a text document which is to be analysed, represented by text document data 310. The text document data is tokenised, if it is not already tokenised, whereupon the same tokenised text document data is provided to each of the first, second and third tagging modules, prepared by the training procedure described above.

Each of the tagging modules outputs a file 312a, 312b, 312c, which comprises token label data in the form of tag data associated with each token in the received document. The first tagging module outputs first tag data which comprises a B tag element in respect of each token which is identified as being at the beginning of an entity which does not contain any nested entities and an I tag element in respect of each token which is identified as being a part, other than the beginning, of an entity which does not contain any nested entities. In either case, the type of the identified entity is also included in the tag data, by way of a further tag element which, together with the B or I tag element, forms the tag data in respect of the token in question.

Tokens which are considered to be part of entities which do not contain other entities, are allocated an O tag element by the first tagging module.

The second tagging module produces second tag data 312b, which corresponds in format to the first tag data, except that the tag data associated with each individual token depends on the identified location of that token within an entity which contains one nested entity. Similarly the third tagging module outputs tag data associated with each token, which tag data relates to the location of the token within entities which include two nested entities.

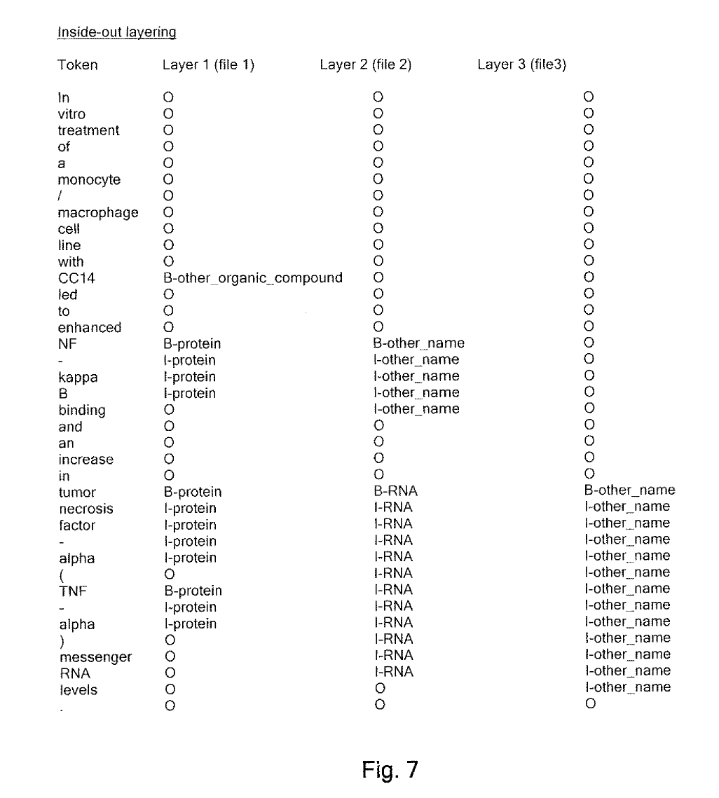

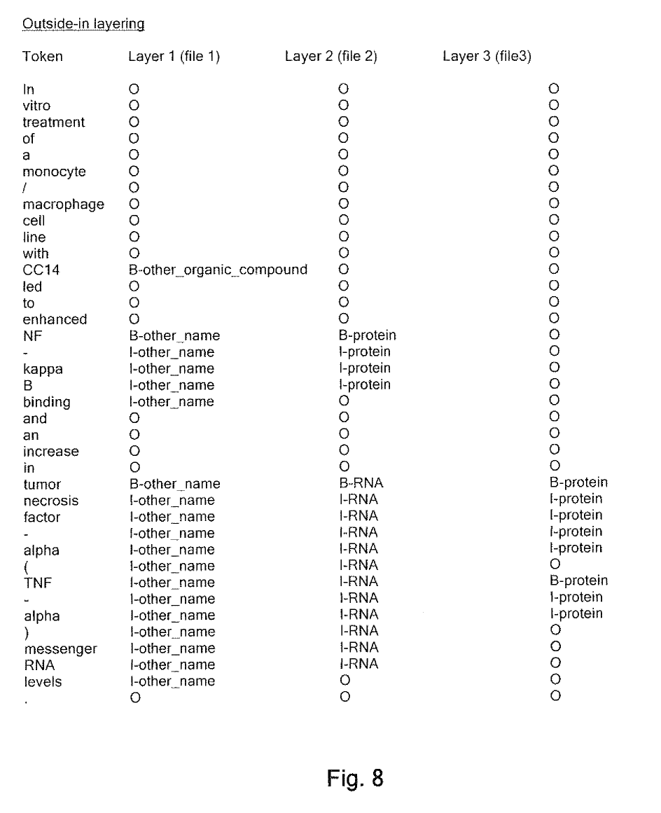

FIG. 7 illustrates the content of three tag data files (functioning as token label data), 312a, 312b and 312c, formatted into a table for the purposes of illustration, and laid out alongside the token within the sentence of FIG. 3, to which each relates. The tag data associated with each token, in each file, includes B, I, or O tag elements, and, in the case of B or I tag elements, a further tag element which indicates the type of entity which the token has been identified as being part of.

The resulting files are processed by a tag processing module, to provide a single output document in which nested entities are identified, for example by stand-off annotation which lists the entities which have been identified and specifies the location of the beginning and end of each identified entity. The location of the beginning and end of each identified entity may be specified by including a reference to the first and last tokens which represent the respective entity. However, one skilled in the art will appreciate that the beginning and end of identified entities may be specified in many ways, for example, by referring to characters where each entity begins and end, or by referring to the token or character before the beginning of the respective entity and/or after the end of the respective entity, or by introducing elements which identify the beginning and end of identified entities into an output document as inline annotation.

The tag processing module may, for example, process the output tag data sequentially, and marking up a text document file with the beginning of an entity when a B tag element is reached in an individual layer, and the end of the entity once an O tag element is identified in the corresponding layer or once a further B tag element is reached if there is no intervening O tag element. Thus, the beginning and end of each entity is identified from the output tag data and stored in the output document in an appropriate format.

One skilled in the art will appreciate that the tag data which is associated with each token (functioning as the token label data) can be stored in any suitable machine-readable format, which communicates the same or equivalent information. The tag data could, for example, be output embedded into a modified version of the received text document data, or stored separately to the text document data. Rather than using a separate tag processing module, each tagging module may be operable to process the token label data which is has produced and output a document which does not include the token label data, but data specifying the start and end, and typically also type, of the recognised named entities represented by the token label data. One skilled in the art will recognise that, although the use of the tag elements B, I and O, may be helpful to fit in with recognised conventions, there is no requirement for the tag elements to use these particular letters.

### Example 2

### Outside-In Layering

In an alternative example embodiment, the first layer is made up of all entities which are not contained within other entities. The second layer is composed of all entities which are contained within one other entity. The third layer is composed of all entities which are contained within two layers of entities. Fourth and further layers may be provided if desired. Only two layers may be provided, for example when analysing data containing only two layers of nested entities.

Again, a tagging module is provided in respect of each layer and trained on text document data, derived from human annotated documents, by labelling the location of each token with tag data comprising a B, I or O tag element, and a tag element denoting the type of entity which the token concerns, only in respect of entities within the respective layer. As before, each tagging module is used separately on a document which is to be analysed to allocate B, I or O tag elements, and identifiers of types of entities, to individual tokens which are identified as belonging to the layer which the respective tagging module concerns. Again, a tag processing module combines the resulting data to produce a single annotated output document file.

In use, essentially identical tokenised documents are passed through each of the tagging modules. Each tagging module, which has been trained on a corresponding layer of entities, outputs label data in respect of each token, which again labels each token with a B, I or O tag element, depending on the identified location of that token within an entity in the respective layer, as well as an identifier of the type of each identified entity. The resulting labels are then used to provide a combined document, labelled with stand-off annotation as illustrated in FIG. 4, in which each recognised entity is annotated.

### Example 3

### Cascading

In a third example embodiment, each document is again analysed by a plurality of separate tagging modules 356a, 356b, 356c, each of which recognises a different subset of entities. In this case the subsets differ in terms of the entities which they contain and each tagging module is adapted to recognise one or more different types of entity. The tagging modules are obtained by training using documents in which only the corresponding types of entity have been marked up.

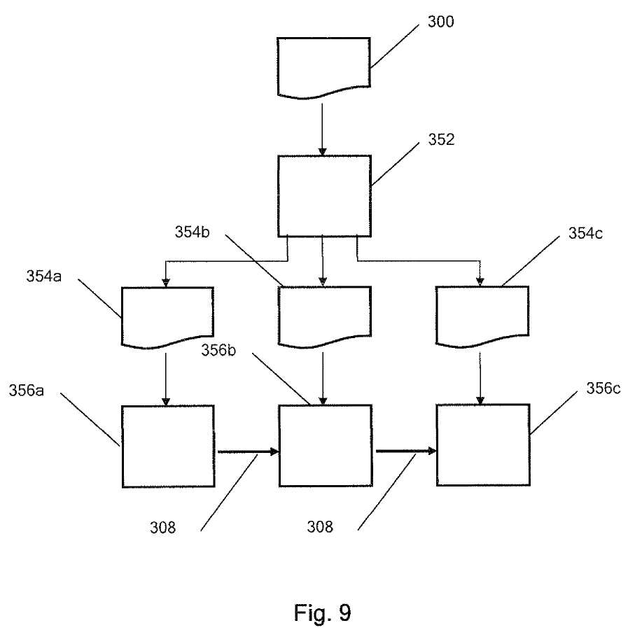

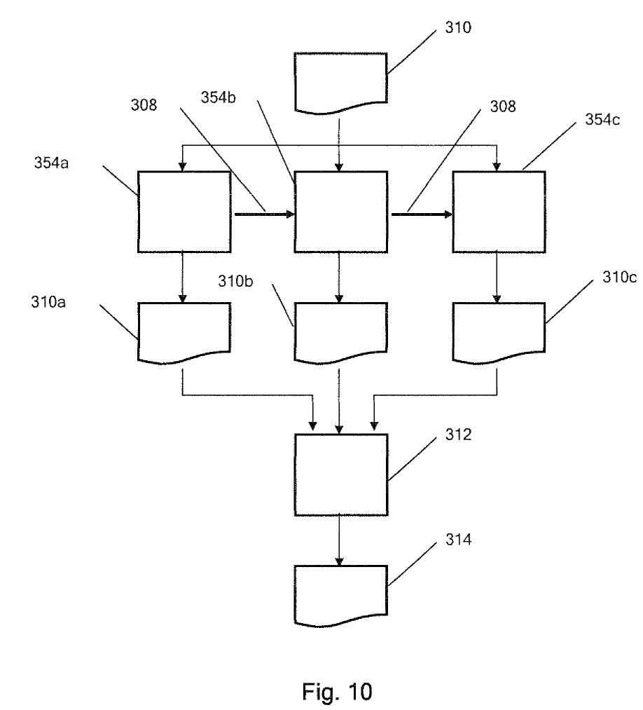

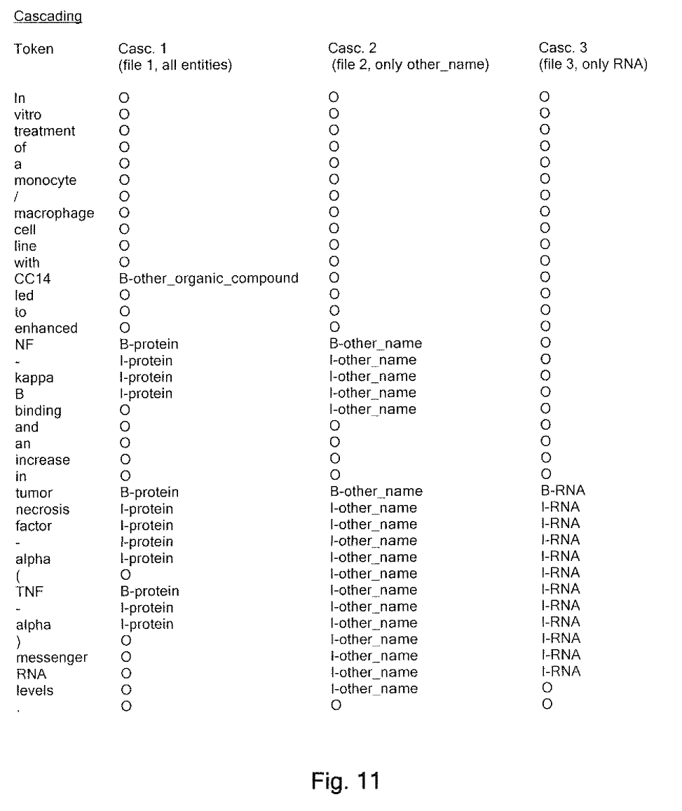

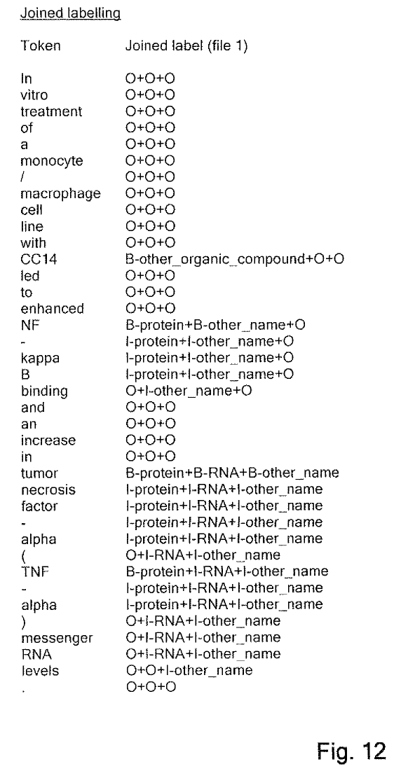

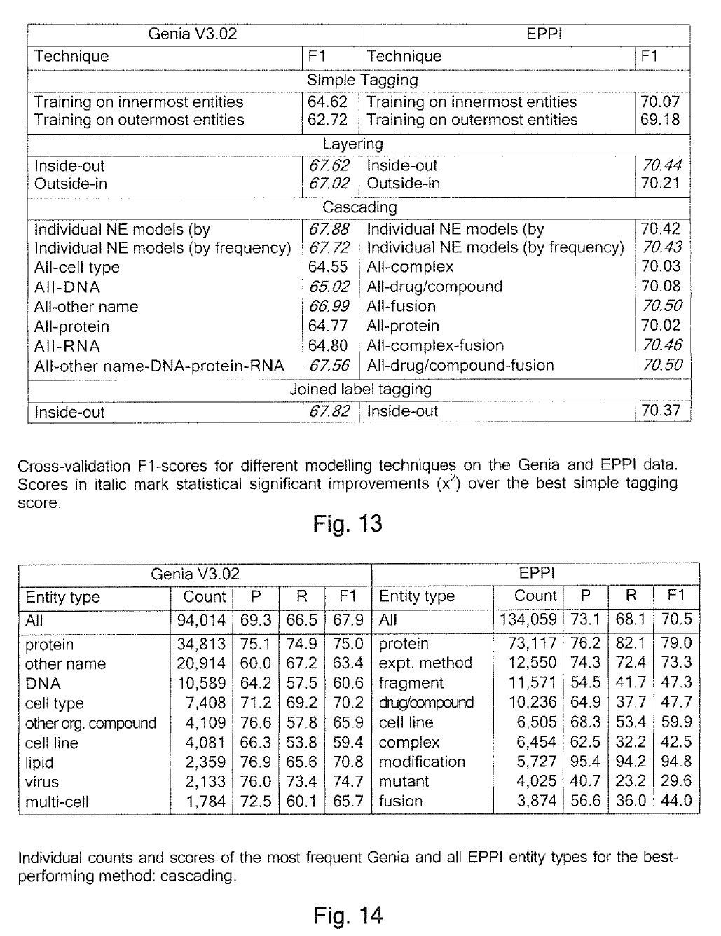

With reference to FIG. 9, human annotated text documents 310, are processed by a document processing module 352 which, as before, provides first, second and third training documents 354a, 354b, 354c from each human annotated text document. However, in this case, the first training documents for training the first module have all entities of one or more specified types, such as proteins, marked up by token with a B tag element if it is the first token in an entity of that type, an I tag if it is inside an entity of that type, and otherwise an O tag element. If there are a plurality of possible entity types to be recognised by each individual module, then it is also advantageous to include an identifier of the type of each entity as a further tag element. Similarly, a second training document is created for each human annotated training document, in which corresponding tags have been associated with each token depending on the location of the token within an entity of the type and associated with the respective tagging module. Third, and optionally fourth, fifth and so forth training documents are also prepared for training further tagging modules.

As with the first and second examples, each tagging module is trained on the respective set of training documents, and the resulting trained tagging module is used during subsequent named entity recognition on documents which are to be analysed at run time. In contrast to the methods of the first and second examples, during both training and execution, the second tagging module inputs and takes into account the tag guessed by the first training module 308 for the corresponding token. Similarly, the third and any subsequent tagging modules each take into account the guess of the previous tagging module. We have found that this improves the performance of the resulting NER module. The types of entity to be identified by each of the first, second, third and any subsequent tagging modules are best established by an empirical procedure, specific to a particular application. In alternative embodiments, only two tagging modules which recognise different subsets of entities, or four or more tagging modules which recognise different subsets of entities, may be provided.

### Example 4

### Joined Label Tagging

In a fourth example embodiment, each token of the human annotated training document is tagged with a tag selected (functioning as token label data) from a potentially large group of tags. The tags in the group of tags are compound tags, comprising separate tag elements representative of the position of the token within entities in each of the layers discussed in relation to the first example above (inside-out layering). Tag elements are also provided which are representative of the type of entity which each B or I tag element concerns.

In contrast to the first three examples, the tag data which used for training the single tagging module and then output by the single tagging module in use, comprises a tag selected from the resulting large group of possible compound tags.

Although we would have anticipated that the quality of the output from the resulting tagging module would be poor, due to the relative sparsity of available training data as each possible tag will only arise infrequently, we have, surprisingly, found that this produces reasonably good quality named entity recognition.

In alternative implementations of joined-label tagging, each possible compound tag is made up from tags representing the location of the token within entities in each of the various layers discussed in relation to Example 2 above (outside-in layering), or in each of the subsets of entities of specific types discussed in relation to Example 3 above (cascading).

Furthermore, one skilled in the art will recognise that the use of a group of tags in the form of compound tags is only one possible approach. The same principle can be applied by selecting the tag for each token from any group of possible tags, in which the group of possible tags includes different tags provided in respect of each possible combination of the location of the token within two or more entities. Typically the two or more entities are selected from different subsets of possible entities. Separate tags may be provided within the group of possible tags depending on the type of each of the two or more entities of which the token is part.

Experiments

Experiments were carried out to compare the effectiveness of the different approaches to tagging and NER. The experiments aimed to recognise all levels of named entity nesting occurring in two biomedical corpora: the Genia corpus (Version 3.02), which is a large publicly available biomedical corpus annotated with biomedical named entities, and the EPPI corpus which has been collected as part of ongoing research and includes annotations of nine different types of biomedical entities.

The Genia and EPPI Corpora

The Genia corpus contains nested entities having up to four layers of embedding and the EPPI corpus contains up to three layers. The Genia corpus is made up of a larger percentage of both embedded entity (18.61%) and containing entity (16.95%) mentions than the EPPI data (12.02% and 8.27%, respectively).

The Genia corpus consists of 2,000 MEDLINE abstracts in the domain of molecular biology (approximately 500,000 tokens). The annotations used for the present experiments are based on the GENIA ontology, published in Ohta et al. (2002). This ontology contains the following classes: amino acid monomer, atom, body part, carbohydrate, cell component, cell line, cell type, DNA, inorganic, lipid, mono-cell, multi-cell, nucleotide, other name, other artificial source, other organic compound, peptide, polynucleotide, protein, RNA, tissue, and virus. In this work, protein, DNA and RNA sub-types are collapsed to their super-type, as done in previous studies (e.g. Zhou 2006).

The EPPI corpus consists of 217 full-text papers selected from PubMed and PubMedCentral as containing protein-protein interactions (PPIs). The papers were either retrieved in XML or HTML, depending on availability, and converted to an internal XML format. Domain experts annotated all documents for named entities and PPIs, as well as extra (enriched) information associated with PPIs and normalisations of entities to publicly available ontologies. The entity annotations are the focus of the current work. The types of entities annotated in this data set are: complex, cell line, drug/compound, experimental method, fusion, fragment, modification, mutant, and protein. Out of the 217 papers, 125 were singly annotated, 65 were doubly annotated, and 27 were triply annotated. The IAA, measured by taking the F1 score of one annotator with respect to another when the same paper is annotated by two different annotators, ranges from 60.40 for the entity type mutant to 91.59 for protein, with an overall micro-averaged F1-score of 84.87. The EPPI corpus (approximately two million tokens) is divided into three sections, TRAIN (66%), DEVTEST (17%), and TEST (17%), with TEST only to be used for final evaluation, and not to be consulted by the researchers in the development and feature optimisation phrase. The experiments described here involve the EPPI TRAIN and DEVTEST sets.

In both corpora, nesting occurs in three different ways. Firstly, entities containing one or more shorter embedded entities are very frequent in both data sets. For example, the DNA “IL-2 promoter” in the Genia corpus contains the protein “IL-2”. In the EPPI corpus, fusions and complexes often contain nested proteins, e.g. the complex “CBP/p300”, where “CBP” and “p300” are marked as proteins. Secondly, entities with more than one entity type occur in both data sets, although they are very rare in the Genia corpus. For example, the string “p21ras” is annotated both as DNA and protein. In the EPPI data, proteins can also be annotated as drug/compound where it can be clearly established that the protein is used as a drug to affect the function of an organism, cell or biological process. Finally, coordinated named entities account for approximately 2% of all named entities in the Genia and EPPI data. In the original corpora they are annotated differently but for this work they are all converted to a common format. The outermost annotation of coordinated structures and any continuous entity mark-up within them is retained. For example, in “human interleukin-2 and -4,” both the continuous embedded entity “human interleukin-2” and the entire string are marked as proteins. The markup for discontinuous embedded entities, like “human interleukin-4” in the previous example, is not retained as they can be derived in a post-processing step once nested entities are recognised.

Pre-processing

All documents were passed through a sequence of preprocessing steps implemented using the LT-XML2 and LT-TTT2 tools (Grover et al., 2006) with the output of each step encoded in XML mark-up. Tokenisation and sentence splitting is followed by part-of speech tagging with the Maximum Entropy Markov Model (MEMM) tagger developed by Curran and Clark (2003) (hereafter referred to as C&C) for the CoNLL-2003 shared task (Tjong Kim Sang and De Meulder, 2003), trained on the MedPost data (Smith et al., 2004). Information on lemmatisation, as well as abbreviations and their long forms, is added using the morpha lemmatiser (Minnen et al., 2000) and the ExtractAbbrev script of Schwartz and Hearst (2003), respectively. A lookup step uses ontological information to identify scientific and common English names of species. Finally, a rule-based chunker marks up noun and verb groups and their heads (Grover and Tobin, 2006).

Named Entity Tagging

The C&C tagger, referred to above, forms the basis of the NER component of the TXM natural language processing (NLP) pipeline designed to detect entity relations and normalisations (Grover et al., 2007). The tagger, in common with many machine learning approaches to NER, reduces the entity recognition problem to a sequence tagging problem by using the BIO encoding of entities discussed above. As well as performing well on the CoNLL-2003 task, Maximum Entropy Markov Models have also been successful on biomedical NER tasks (Finkel et al., 2005). As the vanilla C&C tagger (Curran and Clark, 2003) is optimised for performance on newswire text, various modifications were applied to improve its performance for biomedical NER. The following table lists the extra features specifically designed for biomedical text.

| Feature | Description |
|---|---|
| CHARACTER | Regular expressions matching typical protein names |
| WORDSHAPE | Extended version of the WORDTYPE feature |
| HEADWORD | Head word of the current noun phrase |
| ABBREVIATION | Term identified as an abbreviation of a gazetteer |
| | term within a document |
| TITLE | Term seen in a noun phrase in the document title |
| WORDCOUNTER | Non-stop word that is among the 10 most frequent |
| | ones in a document |
| VERB | Verb lemma information added to each noun phrase |
| | token in the sentence |
| FONT | Text in italic and subscript contained in the original |
| | document format |

The C&C tagger was also extended using several gazetteers, including a protein, complex, experimental method and modification gazetteer, targeted at recognising entities occurring in the EPPI data. Further post-processing specific to the EPPI data involves correcting boundaries of some hyphenated proteins and filtering out entities ending in punctuation.

All experiments with the C&C tagger involve 5-fold cross-validation on all 2,000 GENIA abstracts and the combined EPPI TRAIN and DEVTEST sets. Cross-validation is carried out at the document level. For simple tagging, the C&C tagger is trained on the non-containing entities (innermost) or on the non-embedded entities (outermost). For inside-out and outside-in layering, a separate C&C model is trained for each layer of entities in the data, i.e. four models for the GENIA data and three models for the EPPI data Cascading is performed on individual entities with different orderings, either ordering entity models according to performance or entity frequency in the training data, ranging from highest to lowest. Cascading is also carried out on groups of entities (e.g. one model for all entities, one for a specific entity type, and combinations). Subsequent models in the cascade have access to the guesses of previous ones via a GUESS feature. Finally, joined label tagging is done by concatenating individual BIO tags from the innermost to the outermost layer. As in the GENIA corpus, the most frequently annotated entity type in the EPPI data is protein with almost 55% of all annotations in the combined TRAIN and DEVTEST data (see Table 5). Given that the scores reported in this paper are calculated as F1 micro-averages over all categories, they are strongly influenced by the classifier's performance on proteins. However, scoring is not limited to a particular layer of entities (e.g. only outermost layer), but includes all levels of nesting. During scoring, a correct match is achieved when exactly the same sequence of text (encoded in start/end offsets) is marked with the same entity type in the gold standard and the system output. Precision, recall and F1 are calculated in standard fashion from the number of true positive, false positive and false negative named entities recognised

Results

Table 4 lists overall cross-validation F1-scores calculated for all named entities at all levels of nesting when applying the various modelling techniques. For the Genia corpus, cascading on individual entities when ordering entity models by performance yields the highest F1-score of 67.88. Using this method yields an increase of 3.26 F1 over the best simple tagging method which scores 64.62 F1. Joined label tagging results in the second best overall F1-score of 67.82. Both layering (inside-out) and cascading (combining a model trained on all named entities with 4 models trained on other name, DNA, protein or RNA) also perform competitively reaching F1-scores of 67.62 and 67.56, respectively. In the experiments with the EPPI corpus, cascading is also the winner with an F1-score of 70.50 when combining a model trained on all named entities, with one trained on fusions. This method only results in a small, yet statistical significant (X²: p≦0.025), increase in F1 of 0.43 over the best simple tagging algorithm. This could be due to the smaller number of nested named entities in the EPPI data and the fact that this data set contains many named entities with more than one category. Layering (inside-out) performs almost as well as cascading (F1=70.44).

The difference in the overall performance between the Genia and the EPPI corpus is partially due to the difference in the number of named entities which C&C is required to recognise but also due to the fact that all features used are optimised for the EPPI corpus data and simply applied to the Genia corpus. The only feature not used for the experiments with the Genia corpus is FONT as this information is not preserved in the original XML of that corpus.

Discussion of Results

Comparing the results obtained using the different modelling techniques shows that each of the three methods proposed outperforms simple tagging. Cascading yields the best performance for the Genia data (F1=67.88) and the EPPI data (F1=70.50). However, it involves copious amounts of experimentation to determine the best combination of models. The best setup for cascading is clearly data set dependent. With larger numbers of entity types annotated in a given corpus, it becomes increasingly impractical to exhaustively test all possible orders and combinations in the cascade. Moreover, training and tagging times are lengthened the more models are combined in the cascade.

Despite the large number of tags involved in using joined label tagging, this method outperforms simple tagging for both data sets and even results in the second best overall F1-score of 67.72 obtained for the Genia corpus. The fact that joined label tagging only requires training and tagging with one model makes this approach a viable alternative to cascading which is much more time-consuming to run.

Inside-out layering performs competitively both for the Genia corpus (F1=67.62) and the EPPI corpus (F1=70.37), considering how little time is involved in setting up such experiments. As with joined label tagging, minimal optimisation is required when using this method. However, one disadvantage to simple, and to some extent joined label tagging, is that training and tagging times increase with the number of layers that are modelled.

The following references referred to in this document are incorporated herein by virtue of this reference:
James R. Curran and Stephen Clark. 2003. Language independent NER using a maximum entropy tagger. In Proceedings of CoNLL-2003, pages 164-167.
Jenny Rose Finkel, Shipra Dingare, Christopher D. Manning, Malvina Nissim, Beatrice Alex, and Claire Grover. 2005. Exploring the boundaries: Gene and protein identification in biomedical text. BMC Bioinformatics, 6(Suppl1):S5.
Claire Grover and Richard Tobin. 2006. Rule-based chunking and reusability. In Proceedings of LREC 2006, pages 873-878.
Claire Grover, Michael Matthews, and Richard Tobin. 2006. Tools to address the interdependence between tokenisation and standoff annotation. In Proceedings of NLPXML 2006, pages 19-26.
Claire Grover, Barry Haddow, Ewan Klein, Michael Matthews, Leif Arda Nielsen, Richard Tobin, and Xinglong Wang. 2007. Adapting a relation extraction pipeline for the BioCreAtIvE II task. In Proceedings of the BioCreAtIvE Workshop 2007, Madrid, Spain.
Jin-Dong Kim, Tomoko Ohta, Yoshimasa Tsuruoka, Yuka Tateisi, and Nigel Collier. 2004. Introduction to the bioentity recognition task at JNLPBA. In Proceedings of JNLPBA 2004, pages 70-75.
Guido Minnen, John Carroll, and Darren Pearce. 2000. Robust, applied morphological generation. In Proceedings of INLG 2000, pages 201-208.
Tomoko Ohta, Yuka Tateisi, Hideki Mima, and Jun'ichi Tsujii. 2002. GENIA corpus: an annotated research abstract corpus in molecular biology domain. In Proceedings ofHLT2002, pages 73-77.
Lance Ramshaw and Mitch Marcus. 1995. Text chunking using transformation-based learning. In Proceedings of the 3rd Workshop on Very Large Corpora (ACL 1995), pages 82-94.
Ariel S. Schwartz and Marti A. Hearst. 2003. A simple algorithm for identifying abbreviation definitions in biomedical text. In Pacific Symposium on Biocomputing pages 451-462.
Larry Smith, Tom Rindflesch, and W. John Wilbur. 2004. MedPost: a part-of-speech tagger for biomedical text. Bioinformatics, 20(14):2320-2321.
Erik F. Tjong Kim Sang and Fien De Meulder. 2003. Introduction to the CoNLL-2003 shared task: Language-independent named entity recognition. In Proceedings of CoNLL-2003, pages 142-147.
Jie Zhang, Dan Shen, Guodong Zhou, Jian Su, and Chew-Lim Tan, 2004. Enhancing HMM-based biomedical named entity recognition by studying special phenomena. Journal of Biomedical Informatics, 37(6):411-422.
Guodong Zhou. 2006. Recognizing names in biomedical texts using mutual information independence model and svm plus sigmoid. International Journal of Medical Informatics, 75:456-467.

Further variations and modifications may be made within the scope of the invention herein disclosed.

What is claimed is:

1. A method of recognising named entities in a text-containing document, the method comprising:
(i) receiving text document data which represents the text-containing document, the text document data comprising a plurality of tokens which represent parts of the text which the text document data represents, one or more of the said plurality of tokens being part of a plurality of entities;
(ii) analysing the text document data using one or more tagging modules which are operable to determine token label data in respect of at least the tokens which are part of a plurality of entities, wherein the token label data output by the one or more tagging modules comprises data representative of the location of a respective token within each of a plurality of entities; and
(iii) determining the beginning and end of entities represented by the text document data from the said token label data representative of the location of a respective token within each of a plurality of entities.

2. A method of recognising named entities according to claim 1, wherein the text document data is analysed using a plurality of tagging modules, each of which is adapted to determine token label data representative of the location of a token within a different subset of the entities represented by the text document data, wherein the token label data determined by the plurality of tagging modules together is representative of the location of the said token with a plurality of entities.

3. A method of recognising named entities according to claim 2, wherein token label data output by each of the plurality of tagging modules is used to determine the beginning and end of entities represented by the text document data.

4. A method of recognising named entities according to claim 2, wherein each of the plurality of tagging modules are adapted to determine token label data concerning entities which contain, or are contained within, a different number of other entities.

5. A method of recognising named entities according to claim 2, wherein each of the plurality of tagging modules are adapted to determine token label data concerning entities of different types, or groups of types.

6. A method of recognising named entities according to claim 2, wherein the plurality of tagging modules have each trained on training data comprising text document data which represents text-containing documents, and each of the plurality of tagging modules taking into account data concerning different subsets of the entities represented by the text-containing documents.

7. A method of recognising named entities according to claim 2, wherein the text document data is analysed using at least three tagging modules, each of which is adapted to determine token label data representative of the location of a token within a different subset of the entities represented by the text-containing document, wherein the token label data determined by the plurality of tagging modules together is representative of the location of the said token with a plurality of entities.

8. A method of recognising named entities according to claim 2, wherein the token label data representative of the location of a token within a subset of the entities represented by the text-containing document comprises a tag element selected from a group of tag elements, including at least one tag element indicative that the token is at the beginning of an entity with the respective subset of entities and at least one tag element indicative that the token is within, but not at the beginning of, an entity within the respective subset of entities.

9. A method of recognising named entities according to claim 8, wherein, in respect of tokens which are part of an entity within the respective subset of entities, the token further comprises a tag element which indicated the type of the entity, selected from a group of possible entity types.

10. A method of recognising named entities according to claim 1, wherein a single tagging module is adapted to determine token label data concerning the location of tokens within a plurality of different entities, the token label data being selected from a group of tags, the group of tags including different tags in respect of a plurality of different combinations of the location of a respective token within a plurality of entities.

11. A method of recognising named entities according to claim 10, wherein the group of tags comprises a plurality of different tags in respect of the type of two or more of the plurality of entities which the tag is part of.

12. A method of recognising named entities according to claim 10, wherein the group of tags comprises a different tag for each of a plurality of combinations of the location of a respective token within a first entity and the location of the respective token within a second entity and the type of first entity and the type of the second entity.

13. A method of recognising named entities according to claim 10, wherein the text document data is analysed using a plurality of tagging modules, each of which is adapted to determine token label data representative of the location of a token within a different subset of the entities represented by the text-containing document, wherein the token label data determined by the plurality of tagging modules together is representative of the location of the said token with a plurality of entities.

14. A method of recognising named entities according to claim 1, wherein the named entity recognition module is based on a trained statistical model.

15. A method of recognising named entities according to claim 10, wherein the named entity recognition module is based on a trained Maximum Entropy Markov Model.

16. Computing apparatus operable to receive text document data which represents a text-containing document and to recognise named entities represented by the text document data by a method according to claim 1.

17. A computer readable storage medium having program code instructions stored thereon which, when executed on computing apparatus, cause the computing apparatus to carry out the method of claim 1.
